(19) United States
(12) Patent Application Publication
(10) Pub. No.: US 2023/0341532 A1
(43) Pub. Date: Oct. 26, 2023

(54) DYNAMIC CALIBRATION METHOD OF AVALANCHE PHOTODIODES ON LIDAR

(71) Applicant: Innovusion, Inc, Sunnyvale, CA (US)

(72) Inventors: Xiandong Leng, San Jose, CA (US); Peng Wan, Fremont, CA (US); Jian Wen, Fremont, CA (US); Gang Zhou, San Jose, CA (US); Yufeng Li, Milpitas, CA (US)

(73) Assignee: Innovusion, Inc, Sunnyvale, CA (US)

(21) Appl. No.: 18/137,954

(22) Filed: Apr. 21, 2023

Related U.S. Application Data
(60) Provisional application No. 63/334,050, filed on Apr. 22, 2022.
(60) Provisional application No. 63/414,348, filed on Oct. 7, 2022.

(51) Int. Cl. G01S 7/497; G01S 7/4913; G01S 7/4861

(52) U.S. Cl. CPC G01S 7/497; G01S 7/4913; G01S 7/4861

(57) ABSTRACT

A method for dynamically calibrating a light detector of a light detection and ranging (LiDAR) system is disclosed. The method comprises obtaining an indication for use. The method further comprises determining, based on the indication, whether to perform the calibration of the light detector operating with a first bias voltage. The method further comprises, in accordance with a determination to perform the calibration, initiating a multiple-point calibration of the light detector across a bias voltage scanning range, wherein the multiple-point calibration comprises determining a second bias voltage corresponding to a current temperature in an operating environment of the light detector. The method further comprises determining, based on the multiple-point calibration, whether to update the first bias voltage based on the second bias voltage.

### CROSS-REFERENCE TO RELATED APPLICATIONS

This application claims priority to U.S. Provisional Patent Application Ser. No. 63/334,050, filed Apr. 22, 2022, entitled “DYNAMIC CALIBRATION METHOD OF AVALANCHE PHOTODIODES ON LIDAR,” and U.S. Provisional Patent Application Ser. No. 63/414,348, filed Oct. 7, 2022, entitled “LIDAR DETECTOR LIVE CALIBRATION.” The contents of both applications are hereby incorporated by references in their entireties for all purposes.

### FIELD OF THE TECHNOLOGY

This disclosure relates generally to light detection and, more particularly, to a method for dynamically calibrating an avalanche photodiode (APD) of a light detection and ranging (LiDAR) system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminates an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Avalanche photodiodes (APDs), which convert light signals to electrical signals, are popular for use as optical sensors in LiDAR systems and other light sensing systems. APDs can also amplify light signals so that the light signals are detectable. The intrinsic physical properties of APDs allow APDs to have high detection performance, but also make APDs sensitive to temperature fluctuations. For example, the output gain of an APD varies based on a bias voltage applied to it and its surrounding temperature. In a thermal static environment, the output gain of an APD mainly depends on its bias voltage. Thus, in a thermal static environment, it is relatively easy to find an optimized bias voltage that allows an APD to work properly without avalanche. When the temperature changes, it becomes more difficult to find the optimized bias voltage for proper operation of the APD. Currently, calibration of the APD bias voltage against temperature changes is typically performed only once at the time the APD is manufactured. However, in practice, temperature in an operating environment (e.g., in an operating environment of a vehicle equipped with a LiDAR comprising APD optical sensors) can vary within a wide range and sometimes change rapidly. As such, when a LiDAR system comprising an APD optical sensor operates in the field and temperature changes, the APD bias voltage can deviate from the optimized value. In high temperatures, to have the same amount of gain as in lower temperatures, a higher bias voltage may need to be provided so that an APD can work properly.

Embodiments of the present disclosure provide a method to dynamically calibrate an APD of a LiDAR system, so that a proper bias voltage can be provided and updated to the APD. The method includes steps for optimizing the APD bias voltage dynamically, such as when the operating temperature changes. To dynamically calibrate an APD, a multiple-point calibration of the APD across a bias voltage scanning range is initiated. A plurality of data points at each of a plurality of bias voltage values across the bias voltage scanning range are obtained and used to determine a voltage correction curve. The voltage correction curve may be a linear fitting of a reciprocal of output intensity (1/Iₒ) of the LiDAR system (e.g., the intensity of output from a LiDAR receiver including an APD, amplifier, and ADC) versus bias voltages across the bias voltage scanning range. A bias voltage corresponding to a current temperature in an operating environment of the APD is determined based on the voltage correction curve. Using the disclosed method, a voltage correction curve of the APD can be used to obtain optimized bias voltages in various operating conditions, thereby facilitating providing the correct bias voltages to the APD.

In one embodiment, a method for dynamically calibrating an avalanche photodiode (APD) of a light detection and ranging (LiDAR) system is provided. The method comprises obtaining an indication for use in determining whether to perform a calibration of a first bias voltage used for operating the APD. The method further comprises determining whether to perform the calibration based on the indication. The method further comprises initiating a multiple-point calibration of the APD across a bias voltage scanning range in accordance with a determination to perform the calibration. The multiple-point calibration comprises determining a second bias voltage corresponding to a current temperature in an operating environment of the APD. The method further comprises determining whether to update the first bias voltage based on the second bias voltage based on the multiple-point calibration.

In one embodiment, a light detection and ranging (LiDAR) system is provided. The LiDAR system is configured to perform a method for dynamically calibrating an avalanche photodiode (APD). The method comprises obtaining an indication for use in determining whether to perform a calibration of a first bias voltage used for operating the APD. The method further comprises determining whether to perform the calibration based on the indication. The method further comprises initiating a multiple-point calibration of the APD across a bias voltage scanning range in accordance with a determination to perform the calibration. The multiple-point calibration comprises determining a second bias voltage corresponding to a current temperature in an operating environment of the APD. The method further comprises determining whether to update the first bias voltage based on the second bias voltage based on the multiple-point calibration.

In one embodiment, a vehicle is provided. The vehicle comprises a LiDAR system configured to perform a method for dynamically calibrating an avalanche photodiode (APD). The method comprises obtaining an indication for use in determining whether to perform a calibration of a first bias voltage used for operating the APD. The method further comprises determining whether to perform the calibration based on the indication. The method further comprises initiating a multiple-point calibration of the APD across a bias voltage scanning range in accordance with a determination to perform the calibration. The multiple-point calibration comprises determining a second bias voltage corresponding to a current temperature in an operating environment of the APD. The method further comprises determining whether to update the first bias voltage based on the second bias voltage based on the multiple-point calibration.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an example LiDAR system having an optical receiver and light detector for detecting and processing return signals according to an embodiment.

FIG. 8 is a diagram illustrating a relation between a reference intensity and bias voltage for an APD in accordance with one embodiment of the present invention.

FIG. 9 illustrates a graphical representation of a multiple-point APD calibration result for an APD operating at 34° C. in accordance with one embodiment of the present invention.

FIG. 10 illustrates a graphical representation of a multiple-point APD calibration result for an APD operating at 107° C. in accordance with one embodiment of the present invention.

FIG. 11 illustrates a graphical representation of a multiple-point APD calibration result for an APD operating at −7° C. in accordance with one embodiment of the present invention.

FIG. 12 is a flowchart illustrating using an exemplary method for dynamically calibrating an avalanche photodiode (APD) of a LiDAR system.

FIG. 13 is a flowchart illustrating using an exemplary method for dynamically calibrating an avalanche photodiode (APD) of a LiDAR system.

While the invention is described with reference to the above drawings, the drawings are intended to be illustrative, and other embodiments are consistent with the spirit, and within the scope, of the invention.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

A LiDAR system is a frequently-used component of a motor vehicle. Avalanche photodiodes (APDs), which convert light signals to electrical signals, are popular for use as optical sensors in LiDAR systems. APDs can also amplify light signals so that the light signals are detectable. The intrinsic physical properties of APDs allow APDs to have high detection performance but also make APDs sensitive to temperature fluctuations. For example, the output gain of an APD varies based on a bias voltage applied to it and its surrounding temperature. In a thermal static environment, the output gain of an APD mainly depends on bias voltage. Thus, a thermal static environment, it is relatively easy to find an optimized bias voltage that allows an APD to work properly without avalanche. When the temperature changes, it becomes more difficult to find the optimized bias voltage for proper operation of the APD. Currently, calibration of the APD bias voltage against temperature changes is typically performed only once at the time the APD is manufactured. However, in practice, temperature in an operating environment (e.g., in an operating environment of a vehicle equipped with a LiDAR comprising APD optical sensors) can vary within a wide range and sometimes change rapidly. As such, when a LiDAR system comprising an APD optical sensor operates in the field and temperature changes, the APD bias voltage can deviate from the optimized value. In high temperatures, to have the same amount of gain as in lower temperatures, a higher bias voltage may need to be provided so that an APD can work properly.

Embodiments of the present disclosure provide a method to dynamically calibrate an APD of a LiDAR system, so that a proper bias voltage can be provided and updated to the APD. The method includes steps for optimizing the APD bias voltage dynamically, such as when the operating temperature changes. To dynamically calibrate an APD, a multiple-point calibration of the APD across a bias voltage scanning range is initiated. A plurality of data points at each of a plurality of bias voltage values across the bias voltage scanning range are obtained and used to determine a voltage correction curve. The voltage correction curve may be a linear fitting of a reciprocal of output intensity (1/Iₒ) of the LiDAR system (e.g., the intensity of output from a LiDAR receiver including an APD, amplifier, and ADC) versus bias voltages across the bias voltage scanning range. A bias voltage corresponding to a current temperature in an operating environment of the APD is determined based on the voltage correction curve. Using the disclosed method, a voltage correction curve of the APD can be used to obtain optimized bias voltages in various operating conditions, thereby facilitating providing the correct bias voltages to the APDs.

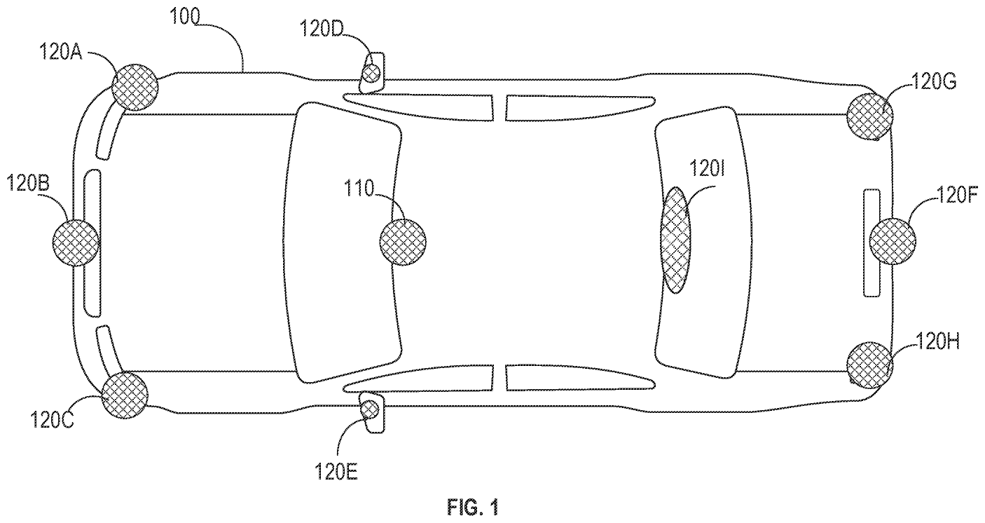

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 1201 is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-1201 are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-1201 include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-1201 may be at least partially exposed to the external environment.

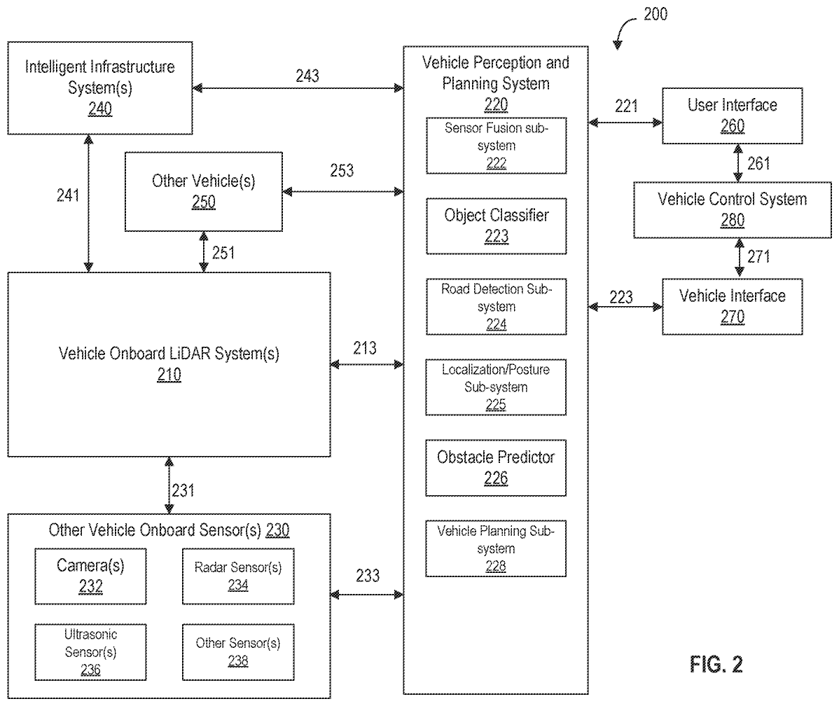

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensors(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

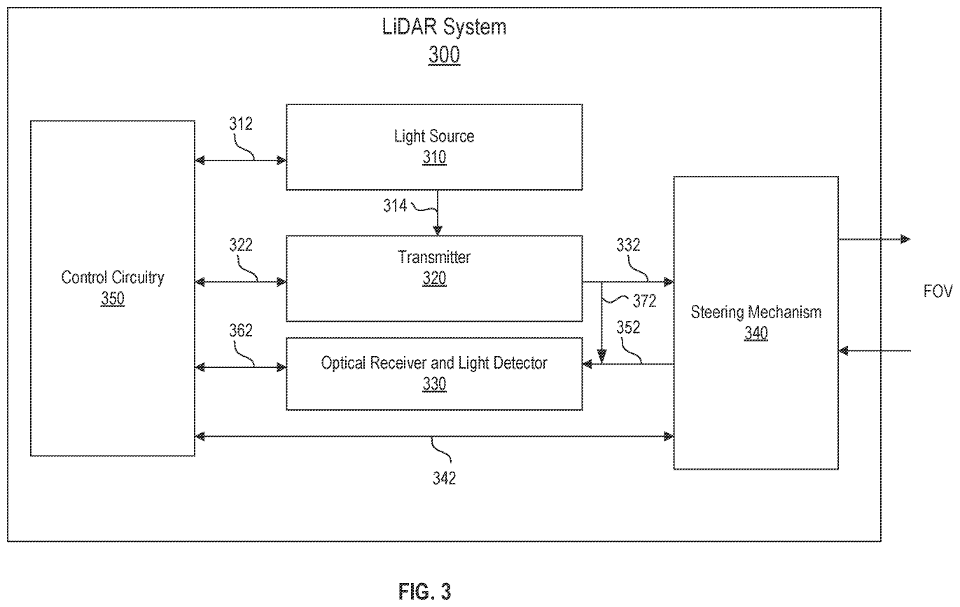

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

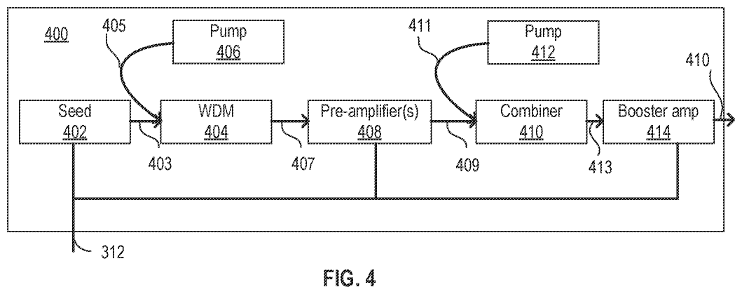

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The outputted light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two- dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

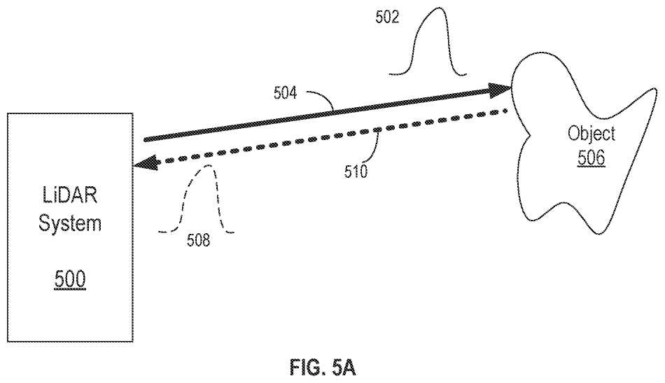

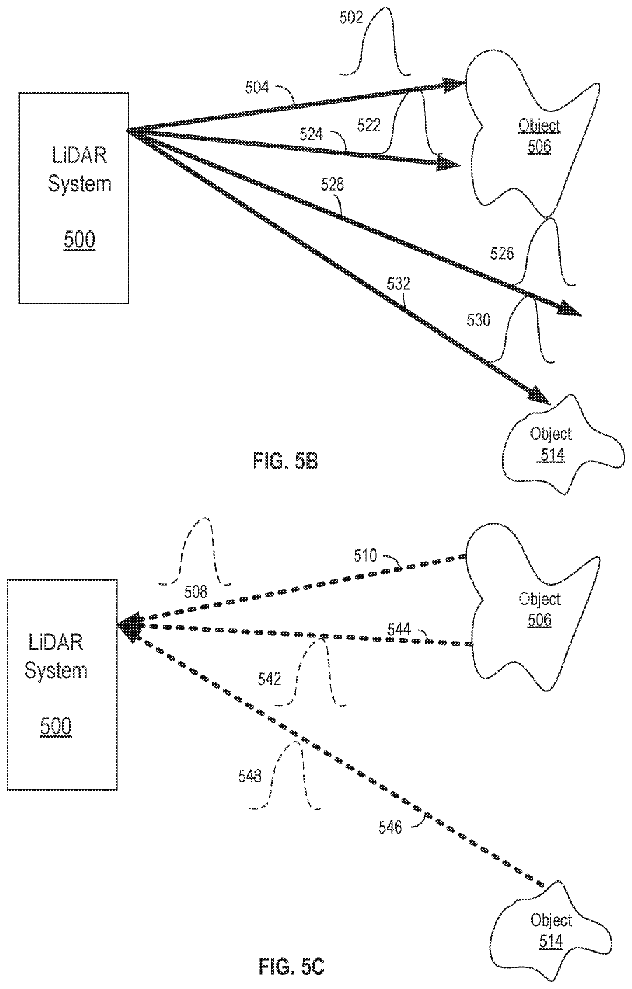

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

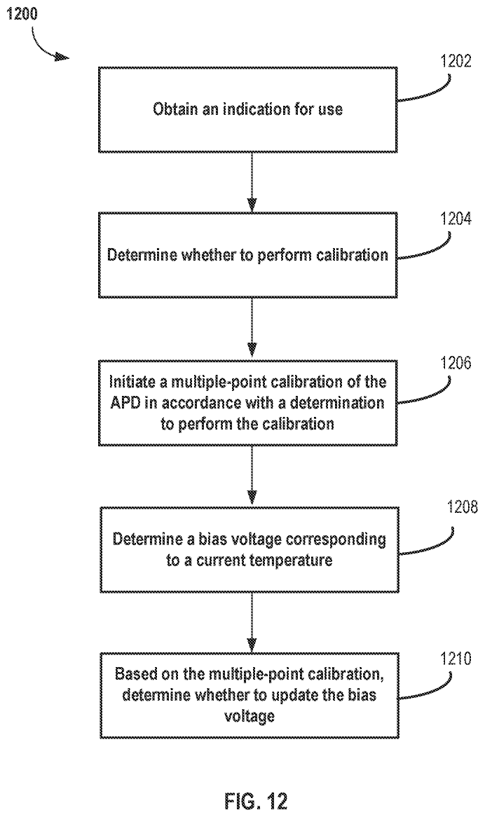

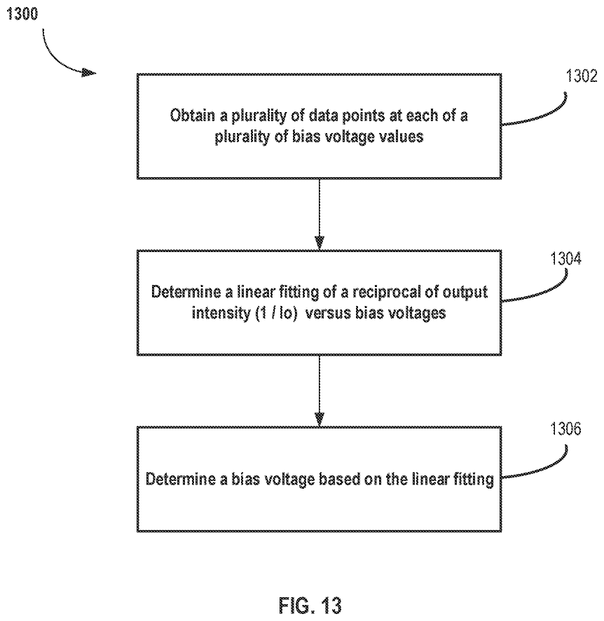

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 12-13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

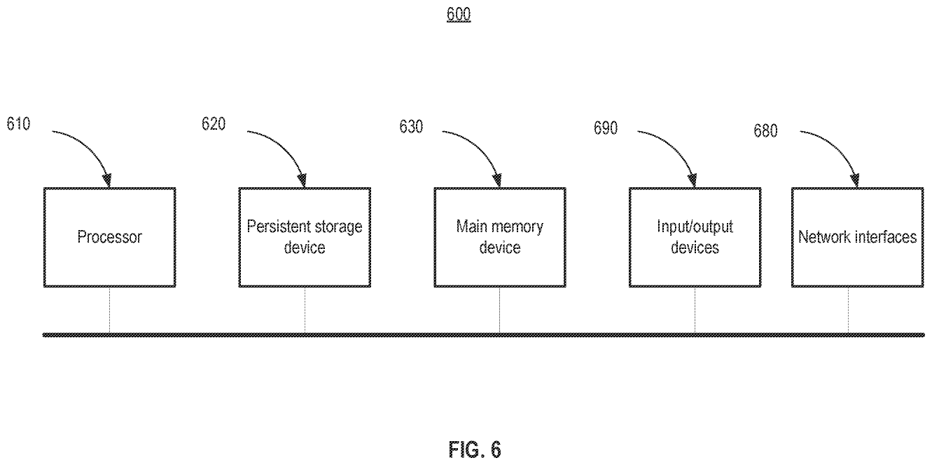

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 12-13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 12-13. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

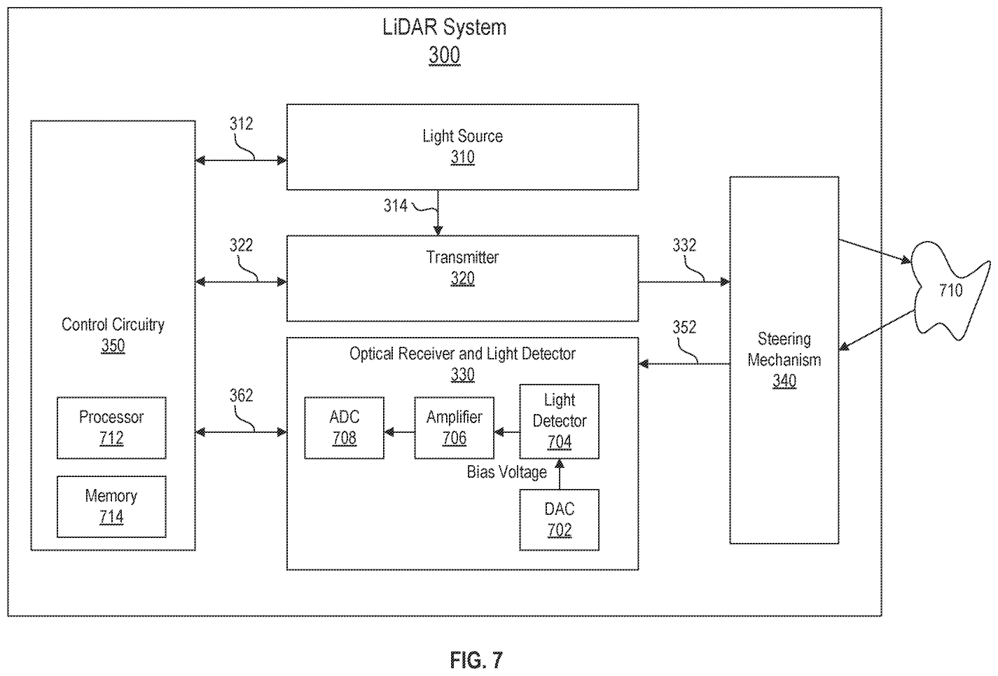

FIG. 7 is a block diagram illustrating an example LiDAR system 300 having an optical receiver and light detector 330 for detecting and processing return signals according to an embodiment. LiDAR system 300 illustrated in FIG. 7 include components and sub-systems that are the same or similar to system 300 shown in FIG. 3. With reference to FIG. 7, in some embodiments, LiDAR system 300 includes an optical receiver and light detector 330. Optical receiver and light detector 330 includes one or more optics for receiving return signals (not shown), a light detector 704, an amplifier 706, an ADC 708, and a digital-to-analog converter (DAC) 702. The optical receiver is configured to collect return signals from the FOV, using for example a collection lens. In some examples, the return signals are directed by steering mechanism 340 to the optical receiver via path 352. The return signals may include return light pulses formed by reflection of transmission light by object 710 in the FOV, scattered light (e.g., formed by a window of LiDAR system 300), background noise, etc. The optical receiver can include one or more optical lenses, lens groups, mirrors, prims, or the like to receive, focus, and direct the return signals. Light detector 704 detects the return signals received by the optical receiver and generates electrical current and/or voltage signals proportional to the incident intensity of the return signals. Light detector 704 can be an avalanche photodiode (APD). Light detector 704 can also be other types of light sensors such as photoresistors, photovoltaic devices, phototransistors, and photodiodes. Light detector 704 can also include filters to selectively pass light of certain wavelengths. In some examples, light detector 704 can transmit signals via communication path 362 to control circuitry 350 indicating when returned light pulses are detected. Other data related to the return light pulses, such as amplitude, power, pulse shape, and wavelength, etc., of the return light pulses may also be transmitted via communication path 362 to control circuitry 350.

With reference to FIG. 7, optical receiver and light detector 330 includes a digital-to-analog converter (DAC) 702, an amplifier 706, and an analog-to-digital converter (ADC) 708. Alternatively or additionally, optical receiver and light detector 330 may include a time-to-digital converter (TDC) instead of an ADC. DAC 702 can receive digital control signals from, e.g., control circuitry 350. Based on the digital control signals, DAC 702 generates an analog signal as a bias voltage for the light detector 704. For instance, if the light detector 704 is an APD, a bias voltage is applied across the APD to generate the electric field required for avalanche multiplication to occur. The gain of APD varies based on the bias voltage applied to it and ambient temperature of the APD. In high temperatures, to have the same amount of gain as in lower temperatures, a higher bias voltage needs to be provided by DAC 702. Since a LiDAR scanning system often operates in a field where temperature may change widely, proper bias voltages need to be provided to the APD, particularly when a vehicle is starting. If the bias voltage is too low, the APD may not provide the desired sensitivity and gain. If the bias voltage is too high, the APD may be damaged or its performance may be degraded due to excess noise or other factors. With the proper control of the input to DAC 702, the proper bias voltage can be selected to place the APD in its optimal operational range.

In some examples, the analog electrical current and/or voltage signals generated by light detector 704 are provided to amplifier 706. Amplifier 706 can amplify the signals for further processing. In one embodiment, amplifier 706 may be a transimpedance amplifier (TIA), which converts an electrical current signal generated by light detector 704 into a voltage signal, and amplifies the voltage signal to a level suitable for further processing. The output of amplifier 706 is analog signals. The analog signals are provided to ADC 708, which is configured to convert the analog signals to digital signals, which approximate the input analog signals. The outputs of ADC 708 are ADC data representing the detected return signals. In some examples, ADC 708 converts an analog signal to a digital signal in two stages: sampling and quantization. In the sampling stage, the analog signal is measured (or sampled) at specific intervals, and the values obtained are stored as digital samples. In the quantization stage, the amplitude of each sample is rounded off to the nearest digital value, based on the number of bits used for representation.

After ADC 708 converts the voltage signals from analog signals to digital signals. The digital signals are sent to control circuitry 350 as ADC data. As described above, control circuitry 350 may include one or more processors (e.g., processor 712) and memory devices (e.g., memory 714) for processing the ADC data to determine, e.g., the timing of the return light pulses for distance calculation and point cloud construction.

Dynamic calibration of the light detector 704 can be performed by the control circuitry 350, and/or other computing systems, by using one or more of DAC 702, amplifier 706 and ADC 708. The below description of a dynamic calibration method uses APD as an example, but it is understood that the same or similar method can be applied to other types of light detectors that require calibration with respect to operating temperatures. During a dynamic calibration of the light detector 704 (e.g., an APD), bias voltages are scanned from a low value to a target value. In some examples, the target value is a default value. In some examples, a large range of calibration of bias voltage is performed, particularly when a LiDAR system is starting. During a large range of calibration, the bias voltage may be scanned from a low value (e.g., 20% of a target value) to the target value. In some examples, a small range of calibration of bias voltage is performed, particularly when the LiDAR system is in use. During a small range of calibration, the bias voltage may be scanned within a small range (e.g., from 95% to 100% of a target value) to the target value. Calibration with a small range is efficient and may not affect the LiDAR system's performance, particularly when the LiDAR system is in use. A multiple-point calibration of APD uses multiple points across a bias voltage scanning range to calibrate the APD.

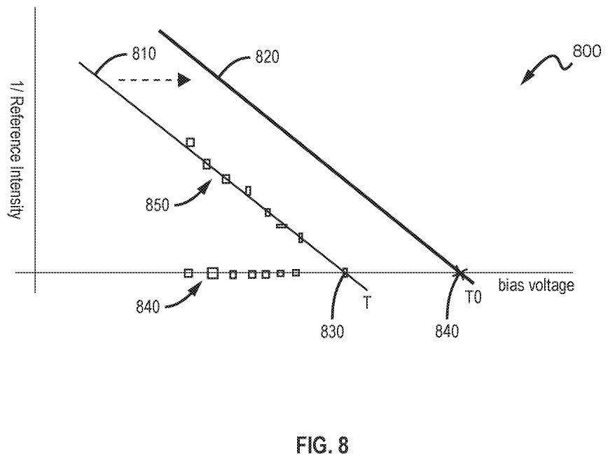

FIG. 8 is a diagram 800 illustrating a relation between a reference intensity and a bias voltage for an APD in accordance with one embodiment of the present invention. Diagram 800 illustrates a relation 810 between the reference intensity and the bias voltage for an APD at temperature T. In some examples, temperature T is the operating temperature of a LiDAR system. In FIG. 8, the horizontal axis represents the bias voltage values across a bias voltage scanning range. In some examples, a bias voltage scanning range is based on a breakdown voltage of the APD. The breakdown voltage of an APD is the voltage at which the avalanche multiplication process starts to occur. In some examples, a bias voltage scanning range may be selected based on a maximum bias voltage of the APD. In FIG. 8, the vertical axis represents the reciprocal of reference intensity (1/Iₒ). A reference intensity is an output intensity at a reference point of the signals coming out of an ADC (e.g., ADC 708 in FIG. 7) of the LiDAR system (e.g., a voltage amplitude). An output intensity is the output signal intensity of the ADC of the LiDAR system. The terms “reference intensity” and “output intensity” may be used interchangeably in this disclosure. As shown in FIG. 8, when the bias voltage of the APD is scanned, a plurality of data points 850 are obtained based on a plurality of bias voltage values 840 at temperature T across the bias voltage scanning range. Each of plurality of data points 850 represents a reciprocal of reference intensity (1/Iₒ) at a corresponding bias voltage of a plurality of bias voltage values 840. In some embodiments, a multi-point calibration obtains at least seven data points at each of the plurality of different bias voltage values. In some embodiments, a multi-point calibration may be a seven-point calibration. For example, as shown in FIG. 8, a plurality of bias voltage values 840 comprises seven bias voltage values. In some embodiments, the seven bias voltage values are distributed evenly across the bias voltage scanning range. A plurality of data points 850 comprises seven data points corresponding to each of the seven bias voltage values respectively. A linear fitting 810 at temperature T is determined using data points 850. Linear fitting 810 represents a relation between a reciprocal of output intensity (1/Iₒ) of the LiDAR system versus bias voltages across the bias voltage scanning range at temperature T. A bias voltage 830 at temperature T is determined by the intersection of linear fitting 810 and the horizontal axis.

While the above multi-point calibration uses seven points as an example, it is understood that any other number of points may be selected for calibration. The number of points may be selected based on the a requirement of calibration speed and/or the accuracy of calibration. For instance, a small number of points may be used for faster calibration but the calibration results may not be accurate (e.g., the linear fitting using a small number of points may not be good). On the other hand, a large number of points may be used for more accurate calibration, but the calibration may need to be performed in a longer time period. It is further understood that while FIG. 8 shows linear fittings are used, other types of fitting may also be used.

As shown in FIG. 8, linear fitting 820 represents a relation between a reciprocal of output intensity (1/Iₒ) of the LiDAR system versus bias voltages across the bias voltage scanning range at temperature To. A bias voltage 840 at temperature To is determined by the intersection of linear fitting 820 and the horizontal axis. For instance, To may be a default temperature value. The default temperature value may be predetermined or may be temperature used for calibration at the time of manufacture. In one embodiment, a multiple-point calibration procedure is initiated automatically when the LiDAR system comprising an APD optical sensor is powered up on a vehicle. The multiple data points for the calibration are obtained at different bias voltages at a default temperature T₀ of the APD. And a bias voltage 840 of the APD is determined by the intersection of linear fitting 820 and the horizontal axis. Thus, a default bias voltage for the LiDAR system, typically set at the time of manufacture, may be updated. A final bias voltage is defined to be the output voltage of a calibration, or a multi-point calibration, process.

As described above, the bias voltage at any temperature can be determined based on scanning the bias voltage and performing linear fitting of the data points. In some embodiments, a fitting quality parameter, R square (or R²), is calculated from the multiple data points and the linear fitting curve to monitor the fitting quality. If R square is greater than a threshold value (e.g., 0.99), which means the fitting is successful, the multiple-point calibration procedure updates the bias voltage of the APD and the bias voltage 840 will be the final bias voltage. If R square is smaller than the threshold value, which means the fitting fails, the multiple-point calibration procedure does not update the bias voltage of the APD, and the default values of bias voltage for the APD will still be used as the final bias voltage. As described above, the default value of the bias voltage may be obtained by calibration at the time of manufacture.

In some embodiments, as shown in FIG. 8, T₀ may be a first temperature and T may be a second temperature or a current temperature. A bias voltage determined at T₀ may be a first bias voltage. A bias voltage determined at T using a multi-point calibration may be a second bias voltage. Once the second bias voltage is determined, the first bias voltage may be updated based on the second bias voltage. In some embodiments, determination on whether to update the first bias voltage based on the second bias voltage depends on a fitting quality parameter. When a fitting quality parameter satisfies a predetermined threshold, the first bias voltage may be determined to be updated. For example, to determine whether to update the first bias voltage or not, a fitting quality parameter, R square, is calculated based on the linear fitting.

R square may be the coefficient of determination defined in statistics. The R square ranges from 0 to 1. A higher R square indicates a better linear fitting. For example, if R square is greater than 0.99, which means the fitting is successful, the multiple-point calibration procedure updates the first bias voltage of the APD with the second bias voltage. If R square is smaller than 0.99, which means the fitting fails, the multiple-point calibration procedure does not update the first bias voltage of the APD.

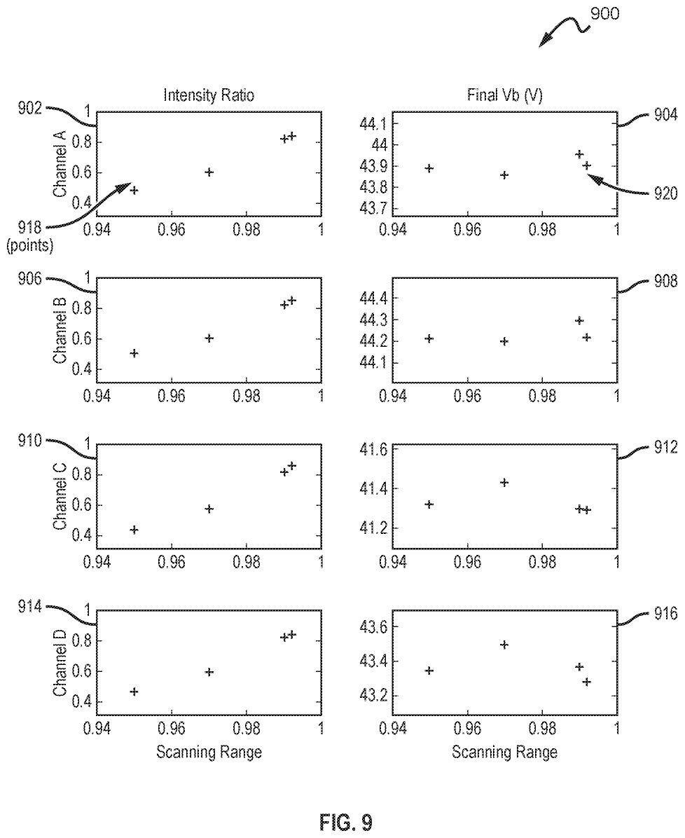

FIG. 9 illustrates a graphical representation 900 of a multiple-point calibration result for an APD operating at 34° C. in accordance with one embodiment of the present invention. In FIG. 9, the horizontal axis of diagrams 902-916 represents a bias voltage scanning range in proportion to a target bias voltage. As shown in FIG. 9, diagrams 902-916 include a small scanning range from 94% to 100% of maximum bias voltage (or target bias voltage). The vertical axis of diagrams on the left side (i.e., diagrams 902, 906, 910, and 914) represents an intensity ratio for a particular scanning channel. A LiDAR system may have multiple scanning channels, each of which includes a receiver and detector. The intensity ratio is a ratio of the LiDAR system's output signal intensity at a particular bias voltage to the output signal intensity at the maximum bias voltage (i.e., at the target bias voltage). With reference to FIG. 9, the vertical axis of diagrams on the right side (i.e., diagrams 904, 908, 912, and 916) represents a final bias voltage. A final bias voltage is defined to be the output voltage of a multiple-point calibration. As described above, the final bias voltage can be determined based on the intersection of the linear fitting with the horizontal axis, as shown in FIG. 8.

As shown in FIG. 9, for example, data points 918 in diagram 902 show that at a temperature of 34 the intensity ratio is about 45% at about 95% bias voltage scanning range, and about 80% at about 99% scanning range. That is, when the bias voltage of the APD varies from about 95% to 99%, the intensity ratio of the output signal may vary widely from 45% to 80%. And data points 920 in diagram 904 show that the respective final bias voltages only vary within about 0.1 V. Therefore, because the final bias voltage does not change significantly, the bias voltage scanning range may not need to vary in a wide range, and instead can be narrowed down to a smaller range. Narrowing down the scanning range can maintain consistency of the final bias voltage and at the same time, the degradation of detection performance is minimized. This is because when the APD is calibrated by varying the bias voltage, the LiDAR system may not function correctly. During the calibration time, the performance of the LiDAR system may be degraded. FIG. 9 shows that at either a larger scanning range or a smaller scanning range, the final bias voltage may not change much. Similarly, as shown by diagrams 906-916, in other scanning channels (e.g., channels B, C, and D), at either a larger scanning range or a smaller scanning range, the final bias voltage does not change much.

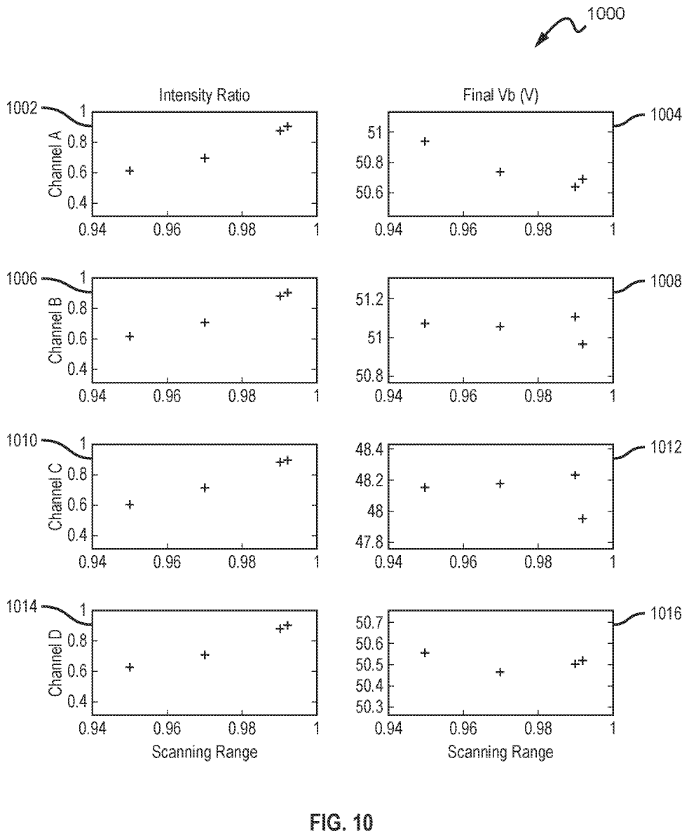

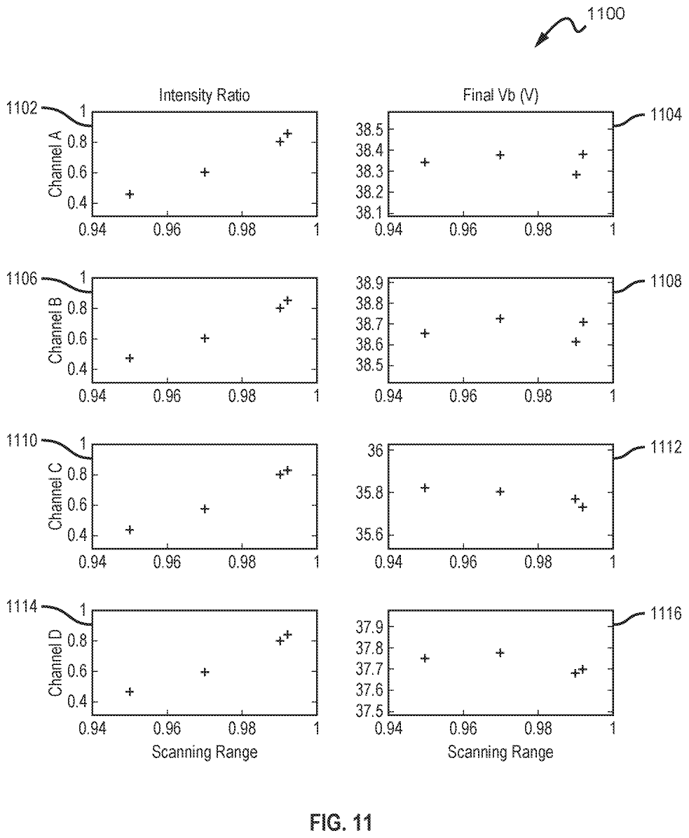

The same conclusion may hold for a relatively high temperature of 107° C. (FIG. 10) and a relatively low temperature of −7° C. (FIG. 11). FIG. 10 illustrates a graphical representation 1000 of a multiple-point APD calibration result for an APD operating at 107° C. in accordance with one embodiment of the present invention. In FIG. 10, the horizontal axis of diagrams 1002-1016 represents a bias voltage scanning range in proportion to a target bias voltage. The vertical axis of diagrams on the left 1002, 1006, 1010, and 1014 represents an intensity ratio. The vertical axis of diagrams on the right 1004, 1008, 1012, and 1016 represents the final bias voltage. Similar to those shown in FIG. 9, as shown in FIG. 10, at either a larger scanning range or a smaller scanning range, the final bias voltage does not change much.

FIG. 11 illustrates a graphical representation 1100 of a multiple-point calibration result for an APD operating at −7° C. in accordance with one embodiment of the present invention. In FIG. 11, the horizontal axis of diagrams 1102-1116 represents a bias voltage scanning range in proportion to a target bias voltage. The vertical axis of diagrams on the left 1102, 1106, 1110, and 1114 represents an intensity ratio. The vertical axis of diagrams on the right 1104, 1108, 1112, and 1116 represents the final bias voltage. Similar to those shown in FIG. 9, as shown in FIG. 11, at either a larger scanning range or a smaller scanning range, the final bias voltage does not change much.

A challenge of a multiple-point calibration is that in a short time window (e.g., a couple of seconds or roughly the time it takes to perform the calibration), the bias voltage of an APD can drop to a value less than or equal to 95% of a maximum value of the scanning range, which can lead to a decrease of detection performance of the LiDAR system, as measured by the intensity ratio. In some embodiments, the dynamic calibration method maintains a consistent calibration result within a narrow voltage scanning range, thereby mitigating such a decrease in detection performance of the LiDAR system.

FIG. 12 is a flowchart illustrating using an exemplary method 1200 for dynamically calibrating an avalanche photodiode (APD) of a LiDAR system. In some embodiments, method 1200 may be performed by LiDAR systems 300 or 700 shown in FIGS. 3 and 7, respectively. Method 1200 may also be performed by other devices (e.g., a remote server, an onboard computer of a vehicle, etc.). Method 1200 includes steps 1202-1210, which may be performed by optical receiver and light detector 330 and/or control circuitry 350 shown in FIGS. 3 and 7. The below description uses control circuitry 350 as an example for performing method 1200.

At step 1202, control circuitry 350 obtains an indication for use. The indication may be obtained in order to determine whether to perform a calibration of a light detector (e.g., an APD) operating with a first bias voltage. The first bias voltage may be, for example, a default bias voltage, or a previously-calibrated bias voltage at a particular temperature. In some embodiments, control circuitry 350 obtains an indication to see whether a first bias voltage is to be calibrated. The indication can be generated and/or obtained based on one or more criteria. For example, the one or more criteria may be based on a change in temperature in an operating environment of the light detector. In one instance, if a temperature change is greater than a threshold value, an indication that a calibration is needed may be generated. In some embodiments, the one or more criteria may be based on a vehicle condition. The vehicle condition may include one or more of the following: a stationary condition, a movement, a rate of speed, a LiDAR usage status, and a LiDAR usage condition. As one example, a calibration of the light detector may be triggered when the vehicle first starts. The calibration may also be performed when the vehicle is in a stational condition such that the calibration-caused LiDAR performance degradation does not impact the vehicle operation. The calibration may be performed when the vehicle is at a low speed to reduce or minimize the impact of calibration-caused LiDAR performance degradation. The calibration may also be triggered by the LiDAR usage status or usage condition. For instance, a calibration may be triggered if the LiDAR is not in use to reduce or minimize the impact of calibration-caused LiDAR performance degradation. A calibration may also be triggered if the LiDAR has been used for a long time period but has not been calibrated, i.e., a calibration is overdue. There may be some other vehicle conditions that may trigger the calibration. In some embodiments, vehicle conditions are detected or reported to control circuitry 350. And an indication may be generated and obtained based on the criteria associated with the vehicle conditions. The indication can be used in the next step to determine if a calibration should be performed.

In some embodiments, the one or more criteria for obtaining an indication may be based on a calibration policy. For example, the calibration policy may include one or more priority rules pertaining to the one or more criteria. The priority rules may define that certain criteria have a higher or lower priority than other criteria. In one example, priority rules can include rules manually set by a user of the LiDAR system or a vehicle driver/system. For example, an autonomous driving system (e.g., system 220 or 280 shown in FIG. 2) can set up a priority rule to delay and/or cancel all indications to perform a calibration within an hour of operation.

In some embodiments, the indication may be obtained from a vehicle control module. For example, the indication may be based on a request obtained from a vehicle controller (e.g., vehicle control system 280 shown in FIG. 2). For instance, when a vehicle detects that the temperature has changed by a certain degree or that LiDAR performance is degrading, the vehicle and/or the LiDAR system may request to perform a calibration. A vehicle of which a light detector is functioning may determine whether to perform a calibration or delay a calibration. In some embodiments, the indication may be obtained at regular intervals. For example, an indication to perform a calibration may be obtained every ten minutes during the operation of a LiDAR system.

At step 1204, control circuitry 350 determines, based on the indication, whether to perform the calibration of the light detector operating with a first bias voltage. In some embodiments, a temperature sensor is used with the light detector to detect changes in temperature. When an operating temperature of the light detector changes by a threshold amount (e.g., 10° C.) during the run-time operation of the LiDAR system, control circuitry 350 may determine that the calibration should be performed. In some embodiments, as described above, for example, a vehicle controller may request to perform the calibration when the vehicle detects that the temperature has changed by a certain degree or that LiDAR performance is degrading or has degraded.

At step 1206, in accordance with a determination to perform the calibration, control circuitry 350 initiates a multiple-point calibration of the light detector across a bias voltage scanning range. In some embodiments, the light detector is an APD and a bias voltage scanning range may be selected based on a breakdown voltage of the APD. The breakdown voltage of the APD may be the minimum voltage that causes the APD to become electrically conductive. In some embodiments, the bias voltage scanning range may be selected based on a maximum bias voltage of the light detector. For example, the bias voltage scanning range may be selected to be between 95% to 100% of a maximum bias voltage of the APD. In some embodiments, a lower limit of the bias voltage scanning range may be selected based on a current intensity ratio of the light detector. For instance, as shown above in FIG. 9, if the minimum intensity ratio is selected to be about 45%, the lower limit of the bias voltage scanning range can be correspondingly selected to be about 95%.

At step 1208, control circuitry 350 performs the multiple-point calibration. During the multiple-point calibration, control circuitry 350 determines a second bias voltage corresponding to a current temperature in the operating environment of the light detector. The process of performing the multiple-point calibration is described in greater detail above in FIG. 8 and below using flowchart 1300 of FIG. 13.

At step 1210, control circuitry 350 determines, based on the multiple-point calibration, whether to update the first bias voltage based on the second bias voltage. In some embodiments, control circuitry 350 calculates a fitting quality parameter based on the linear fitting to determine whether to update the first bias voltage. When the fitting quality parameter satisfies a predetermined threshold, control circuitry 350 determines to update the first bias voltage based on the second bias voltage. In some embodiments, a fitting quality parameter may be R square (or R²), the coefficient of determination defined in statistics, which is calculated from the multiple data points and the linear fitting curve to monitor the fitting quality. If R square is greater than a threshold value (e.g., 0.99), which means the fitting is successful, the multiple-point calibration procedure updates the first bias voltage of the light detector using the second bias voltage. If R square is smaller than the threshold value, which means the fitting fails, the multiple-point calibration procedure does not update the first bias voltage. And the first bias voltage (e.g., a default value of bias voltage or a previously-calibrated bias voltage) can still be used as the current bias voltage for the light detector. More details regarding performing the multiple-point calibration are described as follows along with FIG. 13.

FIG. 13 is a flowchart illustrating using an exemplary method 1300 for dynamically calibrating a light detector (e.g., an APD) of a LiDAR system. In some embodiments, method 1300 may be performed by LiDAR systems 300 or 700 in FIGS. 3 and 7, respectively, including a control circuitry 350. At step 1302, control circuitry 350 obtains a plurality of data points at a plurality of bias voltage values across a bias voltage scanning range. Each of plurality of data points represents a reciprocal of output intensity (1/Iₒ) at a corresponding bias voltage of a plurality of bias voltage values. In some embodiments, the multiple-point calibration comprises obtaining at least seven data points at the plurality of different bias voltage values. For example, a multiple-point calibration may be a seven-point calibration.

At step 1304, control circuitry 350 determines a linear fitting of a reciprocal of output intensity (1/Iₒ) of the LiDAR system versus bias voltages across the bias voltage scanning range using the plurality of data points. For example, to determine a linear fitting, control circuitry 350 finds a line that best describes the relation between the plurality of data points. Control circuitry 350 may determine a linear fitting by a line that minimizes the error or difference between the actual data points and predicted values at the plurality of different bias voltage values. At step 1306, control circuitry 350 determines the second bias voltage based on the linear fitting. For example, the second bias voltage of the light detector is determined by the intersection of the linear fitting and the horizontal axis representing the bias voltage.

In some embodiments, a dynamic calibration method for a light detector (e.g., an APD) of a LiDAR system comprises obtaining a first indication for use. The method comprises determining firstly, based on the first indication, whether to perform a first multiple-point calibration of the APD. The first indication may be generated based on, for example, a vehicle condition indicating the vehicle and/or LiDAR system just started. In accordance with the first determination to perform the first multiple-point calibration, the multiple-point calibration of the APD is performed across a bias voltage scanning range to determine a first bias voltage corresponding to a first temperature. The method also comprises obtaining a second indication for use. The second indication for use may be generated based on, for example, an operating temperature change. The method comprises determining secondly, based on the second indication, whether to perform a second multiple-point calibration of the APD. In accordance with the second determination to perform the second multiple-point calibration, performing the second multiple-point calibration of the APD across a bias voltage scanning range to determine a second bias voltage corresponding to a second temperature. The method also comprises determining whether to update the first bias voltage based on the second bias voltage.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method performed by a processor for dynamically calibrating a light detector of a light detection and ranging (LiDAR) system, the method comprising:
obtaining an indication for use;
determining, based on the indication, whether to perform the calibration of the light detector operating with a first bias voltage;
in accordance with a determination to perform the calibration, initiating a multiple-point calibration of the light detector across a bias voltage scanning range, wherein the multiple-point calibration comprises determining a second bias voltage corresponding to a current temperature in an operating environment of the light detector; and
determining, based on the multiple-point calibration, whether to update the first bias voltage based on the second bias voltage.

2. The method of claim 1, wherein the multiple-point calibration further comprises:
obtaining a plurality of data points at a plurality of different bias voltage values across the bias voltage scanning range;
determining, using the plurality of data points, a linear fitting of a reciprocal of output intensity (1/Iₒ) of the LiDAR system versus bias voltages across the bias voltage scanning range; and
determining the second bias voltage based on the linear fitting.

3. The method of claim 2, wherein obtaining the plurality of data points comprises obtaining at least seven data points at the plurality of different bias voltage values.

4. The method of claim 1, wherein determining whether to update the first bias voltage comprises:
calculating a fitting quality parameter based on the linear fitting; and
determining to update the first bias voltage based on the second bias voltage when the fitting quality parameter satisfies a predetermined threshold.

5. The method of claim 1, further comprising updating the first bias voltage based on the second bias voltage.

6. The method of claim 1, wherein the light detector comprises an avalanche photodetector (APD), and wherein the bias voltage scanning range is based on a breakdown voltage of the APD.

7. The method of claim 1, wherein the multiple-point calibration further comprises selecting the bias voltage scanning range based on a maximum bias voltage of the light detector.

8. The method of claim 1, wherein the multiple-point calibration further comprises selecting a lower limit of the bias voltage scanning range based on a current intensity ratio of the light detector.

9. The method of claim 1, wherein the bias voltage scanning range is between 95% to 100% of a maximum bias voltage of the light detector.

10. The method of claim 1, wherein the indication is obtained based on one or more criteria.

11. The method of claim 10, wherein the one or more criteria is based on a change in temperature in the operating environment of the light detector.

12. The method of claim 11, wherein determining whether to perform the calibration comprises determining whether the change in temperature satisfies a predetermined threshold.

13. The method of claim 10, wherein the one or more criteria is based on a vehicle condition.

14. The method of claim 13, wherein the vehicle condition comprises one or more of the following: a stationary condition, a movement, a rate of speed, a LiDAR usage status, and a LiDAR usage condition.

15. The method of claim 10, wherein the one or more criteria is based on a calibration policy.

16. The method of claim 15, wherein the calibration policy comprises one or more priority rules pertaining to the one or more criteria.

17. The method of claim 1, wherein obtaining the indication comprises obtaining the indication from a vehicle control module.

18. The method of claim 1, wherein obtaining the indication comprises obtaining the indication at regular intervals.

19. A light detection and ranging (LiDAR) system configured to perform a method for dynamically calibrating a light detector, the method comprising:
obtaining an indication for use;
determining, based on the indication, whether to perform the calibration of the light detector operating under a first bias voltage;
in accordance with a determination to perform the calibration, initiating a multiple-point calibration of the APD across a bias voltage scanning range, wherein the multiple-point calibration comprises determining a second bias voltage corresponding to a current temperature in an operating environment of the light detector; and
determining, based on the multiple-point calibration, whether to update the first bias voltage based on the second bias voltage.

20. A vehicle comprising a light detection and ranging (LiDAR) system, the LiDAR system configured to perform a method for dynamically calibrating a light detector, the method comprising:
obtaining an indication for use;
determining, based on the indication, whether to perform the calibration of the light detector operating with a first bias voltage;
in accordance with a determination to perform the calibration, initiating a multiple-point calibration of the APD across a bias voltage scanning range, wherein the multiple-point calibration comprises determining a second bias voltage corresponding to a current temperature in an operating environment of the APD; and
determining, based on the multiple-point calibration, whether to update the first bias voltage based on the second bias voltage.
